(19) United States
(12) Patent Application Publication
(10) Pub. No.: US 2007/0193429 A1
(43) Pub. Date: Aug. 23, 2007

(54) KNIFE BLADE FOR PRODUCING ROUGH SURFACE FRENCH FRY STRIPS

(75) Inventors: Allen J. Neel, Nampa, ID (US); David Bruce Walker, Meridian, ID (US)

Correspondence Address: KELLY LOWRY & KELLEY, LLP, 6320 CANOGA AVENUE, SUITE 1650, WOODLAND HILLS, CA, 91367, US

(73) Assignee: J.R. SIMPLOT COMPANY, Boise, ID (US)

(21) Appl. No.: 11/674,222

(22) Filed: Feb. 13, 2007

Related U.S. Application Data
(60) Provisional application No. 60/766,942, filed on Feb. 21, 2006.

(51) Int. Cl. B26D 7/06; B26D 1/02

(52) U.S. Cl. 83/856; 83/440; 83/932

(57) ABSTRACT

A knife blade in a fixture is provided for cutting vegetable products particularly such as potatoes, wherein the knife fixture includes a grid of knife blades adapted for producing product strips defined by rough-textured cut surfaces. Each knife blade includes a sharp cutting edge for smooth-surface cutting of products propelled hydraulically through the knife fixture. Each knife blade further includes opposed side faces each incorporating an array of shallow channels having an upstream end positioned rearwardly from the associated cutting edge and extending generally in the direction of product travel. These shallow channels disrupt and roughen the cut product surfaces to produce rough-textured cut surfaces. In French fry potato strips, this roughened surface texture results in enhanced surface crispness after frying, or alternately enhances batter pick-up and/or crispness characteristics in a batter-coated French fry product. Enhanced finished product hold time is also achieved.

### BACKGROUND OF THE INVENTION

This invention relates generally to an improved knife blade for use in a knife fixture for cutting vegetable products particularly such as potatoes with a controlled cut surface texture, and to the resultant cut vegetable product. More particularly, this invention relates to an improved knife blade and associated knife fixture for cutting products such as potatoes into elongated French fry strips or like, with a desirably rough-textured cut surface. In French fry potato strips, this roughened cut surface texture results in enhanced surface crispness after frying, or alternately enhances batter pick-up characteristics in a batter-coated French fry product, or enhances crispness in a batter coated French fry product. The roughened cut surface can be used in conjunction with a very light batter coating to produce a crisp texture comparable to that of a standard battered product. This reduction of batter use is a substantial cost savings compared to a standard battered product. The rough cut blade can be used in water knife cutters or in mechanical cutters such as those produced by Urschel Laboratories. The rough cut blade can be used to produce slices, wedges, and diced products. It can be used in a mechanical cutter to produce crinkle cut French fries. The product cut with the improved knife exhibits little or no visual difference from product cut with a conventional knife.

Production cutting systems and related knife fixtures are generally known in the art for cutting vegetable products such as potatoes into smaller pieces of selected size and shape, preparatory to further production processing such as blanching, parfrying, freezing, and/or finish preparation as by finish frying, etc. In this regard, a variety of different knife fixtures are known and commonly used to cut whole potatoes, in a peeled or unpeeled state, into a variety of different specific shapes such as elongated French fry strips having a straight-cut or crinkle-cut configuration, cross-cut slices, wedge-shaped pieces and the like.

In one typical production configuration, the knife fixture comprises an hydraulic-type or so-called water knife fixture having a plurality of knife elements or blades each having a sharp leading or cutting edge and mounted to extend across an elongated tubular conduit in an array which collectively defines a grid for cutting a product such as a potato. A pumping device is provided to entrain the product within a propelling water flume into cutting engagement with the knife blades. The vegetable product is pumped one at a time in relatively rapid single file succession into and through the conduit with a velocity and kinetic energy sufficient to propel the vegetable product through the knife fixture, which severs the product into a plurality of smaller elongated strips at a relatively high production rate. The particular size and shape of the cut product strips is dictated by the grid geometry of the knife blades carried by the knife fixture. In one common form, the knife blades are arrayed to cut potatoes into a plurality of elongated French fry strips having a selected and typically rectangular cross sectional size and shape. The thus-cut product strips are carried further by the flow stream through a discharge conduit which guides the strips to subsequent processing equipment for size grading, cooking, freezing, packaging, and the like. Examples of such hydraulic cutting systems and related water knife constructions are found in U.S. Pat. Nos. 3,109,468; 3,116,772; 3,108,625; 4,082,024; 4,135,002; 4,372,184; 4,423,652; and 7,117,778.

The cut product strips are defined by relatively smooth-cut surfaces in accordance with the specific shape of the knife blade cutting edges. The cut potato pieces are commonly processed by preliminary blanching in hot water or steam, followed by one or more parfrying steps in hot oil prior to final freezing and packaging. In one common production process, the cut potato pieces are also coated with a batter typically comprising an aqueous starch slurry containing selected flavoring and other ingredients, typically prior to parfrying, wherein the batter contributes desirable taste and texture characteristics to the potato pieces when finish prepared, for example, by finish frying or oven heating. See, e.g., U.S. Pat. No. 6,132,785. These product strips such as French fry potato strips, when finish prepared, exhibit a light and tender but crispy exterior surface of golden brown fried color encasing a soft and mealy interior which is neither too dry nor too soggy.

The present invention is directed to an improved knife blade particularly for use in cutting vegetable products such as potatoes with a controlled and rough-textured cut surface which has been found to enhance surface crispness upon subsequent frying of the cut products in hot oil, or alternately to enhance batter pick-up and/or batter adhesion by the cut surface in a batter coated product, or to enhance crispness in a batter coated French fry product. The enhanced crispness and texture causes the product to have a longer acceptable hold time following final preparation in the restaurant. This provides added value to the restaurant operator.

### SUMMARY OF THE INVENTION

In accordance with the invention, a knife blade is provided for cutting vegetable products particularly such as potatoes, wherein the resultant cut products are defined by rough-textured cut surfaces. The knife blade includes a sharp cutting edge for smooth-surface cutting of the products, in combination with opposed side faces each having a textured channel pattern formed thereon with an upstream end of the channeled pattern positioned rearwardly from the cutting edge. As the cut product passes over these textured side face patterns, the smooth-cut surfaces are disrupted and roughened to produce the desired rough-textured cut surface. In French fry potato strips, this roughened surface texture results in enhanced surface crispness after frying, or alternately enhances batter pick-up and batter adhesion characteristics in a batter-coated French fry product, or enhances crispness in a batter coated French fry product. Improved baked product performance and reduced final cook time may also result.

In the preferred form, a plurality or grid of the improved knife blades are carried by a knife fixture for installation along an hydraulic flow path through which the vegetable products are propelled, as by means of a water flume or the like. The sharp cutting edges of the knife blades cut each product into a plurality of elongated strips having a selected cross sectional size and shape. The cut surfaces of these strips pass over the textured channel patterns on the blade side faces to disrupt and roughen the otherwise smooth-cut surfaces and thereby produce the desired rough-textured cut surfaces. In the preferred form, the textured channel patterns each comprise an array of shallow, generally parallel channels having an upstream end positioned rearwardly from the associated cutting edge and extending generally in the direction of product travel. In a most preferred form, the parallel channels on one blade side face are oriented at a small angle, such as an angle of about 3°, to the direction of product travel.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a schematic diagram depicting an hydraulic cutting system incorporating a knife fixture having a plurality of knife blades constructed in accordance with the invention; and

FIG. 2 is an enlarged downstream end perspective view of the knife fixture of FIG. 1;

FIG. 3 is an upstream end elevation view of the knife fixture;

FIG. 4 is an enlarged inboard side elevation view of one of the knife blades constructed in accordance with the invention, for use in the knife fixture depicted in FIGS. 1-3;

FIG. 5 is an enlarged outboard side elevation view of the knife blade shown in FIG. 4;

FIG. 6 is a sectional view taken generally on the line 6-6 of FIG. 5;

FIG. 7 is a perspective view showing an exemplary French fry strip cut by the knife fixture having knife blades constructed according to the invention; and

FIG. 8 is an enlarged outboard side elevation view of a knife blade similar to FIG. 5, but illustrating one preferred alternative form of the invention.

### DETAILED DESCRIPTION OF THE PREFERRED EMBODIMENTS

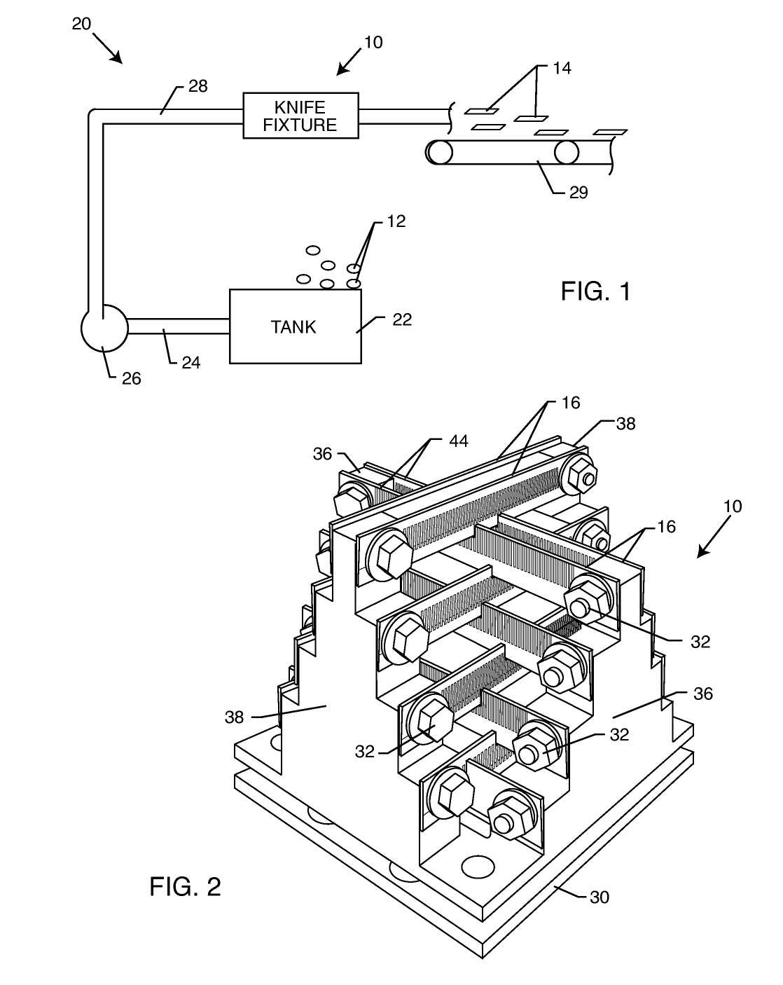

As shown in the exemplary drawings, a knife fixture referred to generally in FIGS. 1-3 by the reference numeral 10 is provided for cutting vegetable products particularly such as whole potatoes 12 (FIG. 1) into elongated strips such as a French fry strip 14 as viewed in FIG. 7. In accordance with the invention, the knife fixture 10 includes a plurality of knife blades 16 constructed to produce the elongated cut strips 14 with relatively rough-textured cut surfaces 18.

FIG. 1 illustrates an exemplary hydraulic cutting system 20 employing the knife fixture 10 to cut whole potatoes 12 into a plurality of elongated French fry potato strips 14. As shown, vegetable products such as whole potatoes 12 are delivered to a reservoir or tank 22 where they are suitably maintained in fluid suspension for facilitated intake flow through an inlet conduit 24 to a pump 26. The pump 26 propels the potatoes 12 in single file relation within a propelling water flow stream or flume through an elongated tubular delivery conduit 28 into cutting engagement with the knife fixture 10. In a typical cutting system, the potatoes are propelled through the delivery conduit 28 at a relatively rapid speed of about 40-60 feet per second. The delivery conduit 28 may incorporate a centering alignment fixture (not shown) for substantially centering each propelled potato on a longitudinal centerline of a flow passage through the knife fixture 10, in a manner known to persons skilled in the art. The cut product pieces such as French fry strips 14 are discharged from the knife fixture 10 onto a suitable conveyor 29 (FIG. 1) for further processing steps.

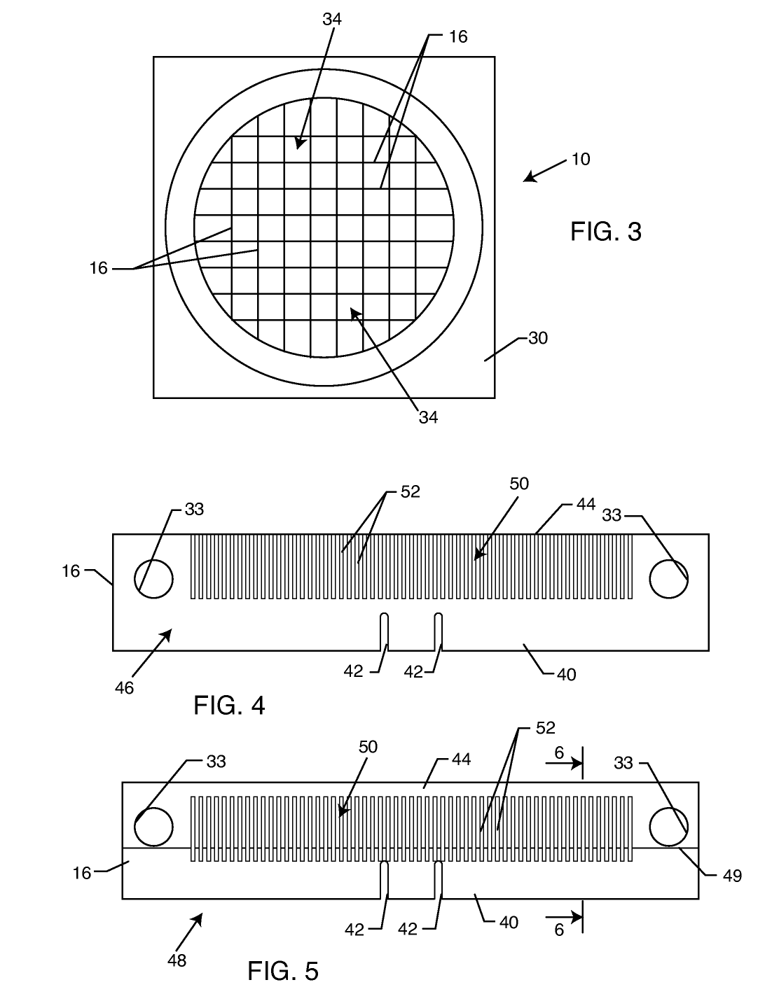

The water knife fixture 10 comprises the plurality of knife elements or blades 16 arranged to extend across a fixture flow passage in a grid pattern selected to cut each whole potato 12 into the plurality of elongated strips 14 of selected cross sectional size and shape. FIGS. 2-3 illustrate one preferred arrangement for the knife blades 16 wherein eight pairs of the knife blades 16 are mounted in an axially and radially staggered pattern onto a fixture block or frame 30 as by means of bolts 32 or the like passed through bolt openings 33 (FIGS. 4-5) at the opposite ends of each knife blade 16. The assembled knife fixture 10, including the eight pairs of knife blades 16, is adapted for removable in-line mounting in a known and suitable manner at a downstream end of the tubular delivery conduit 28. The illustrative drawing shows these knife blades 16 arranged for cooperatively defining a generally rectangular grid (FIG. 3) of rectangular passages 34 each bounded on four sides by adjacent knife blades 16.

As shown best in FIG. 2, the frame 30 of the knife fixture 10 essentially comprises an axially elongated structure for supporting and retaining the knife blades 16 in the axially and radially staggered pattern. In this regard, the illustrative fixture frame 30 includes laterally opposed pairs of axially elongated mounting trees 36 and 38 each defined by a succession of four axially spaced steps which progressively narrow in an upstream-to-downstream direction. The axial positions of these steps on the pairs of frame mounting trees 36 and 38 are axially staggered, and the bolts 32 are fastened into the opposite sides of each tree step for securing the associated pair of knife blades 16 thereto. With this arrangement, a relatively widely spaced-apart first or upstream pair of the knife blades 16 are secured to the leading step of the mounting trees 36 to span therebetween, followed axially by a somewhat narrower spaced-apart second pair of knife blades 16 secured to the leading step of the second pair of mounting trees 38 to span therebetween and to extend generally orthogonal to the first blade pair. This blade mounting sequence continues in an alternating axially spaced pattern.

FIGS. 4-5 illustrate construction details of one of the knife blades 16 of the final blade pair disposed at a downstream end of the knife fixture 10 and secured to the axially downstream step of the frame mounting trees 38, it being understood that these knife blades share key construction features common to the remaining knife blades in the knife fixture 10. As shown, the illustrative knife blade 16 includes a relatively sharp and straight cutting edge 40 extending along an upstream edge thereof for engaging and cutting a vegetable product 12 propelled through the knife fixture 10. In addition, as shown, this cutting edge 40 is interrupted by a pair of short notched recesses 42 positioned for seated reception and support of a trailing edge 44 of the axially upstream-adjacent pair of knife blades 16 mounted onto the frame mounting trees 36 (as shown in FIG. 2). These leading edge notched recesses 42 are spaced apart by an appropriate distance for receiving and supporting the trailing edges 44 of the axially upstream-mounted pair of the knife blades 16, which in turn include cutting edges 40 interrupted by similar but suitably wider-spaced notched recesses 42 for receiving and supporting the trailing edges 44 of the axially adjacent pair of blades mounted immediately upstream relative thereto.

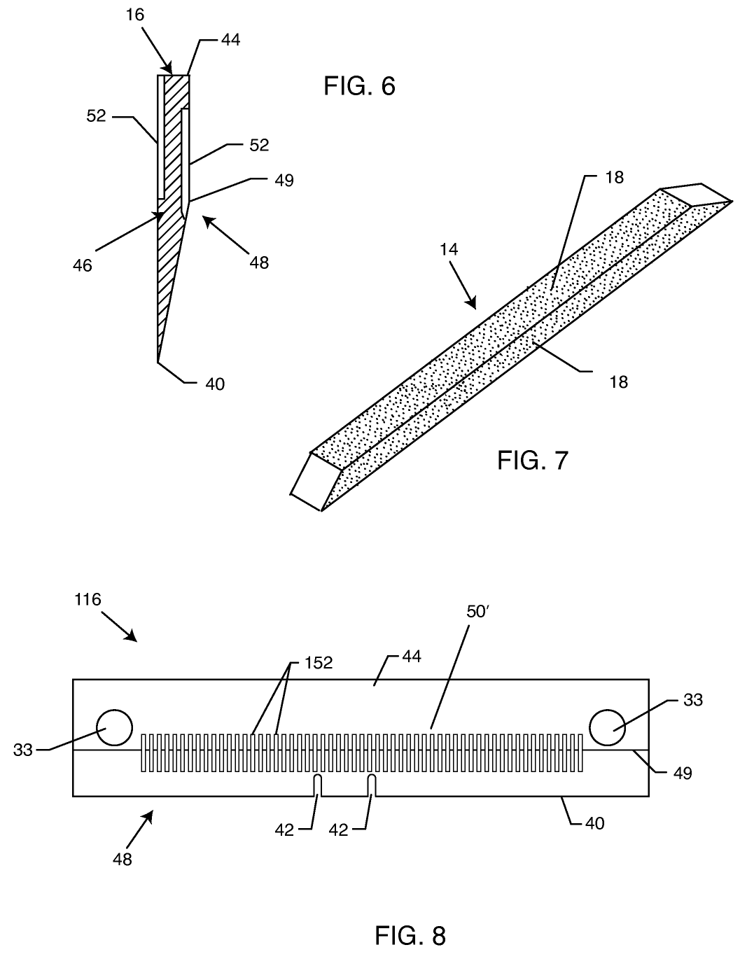

Each knife blade 16 further includes opposed side faces, namely, an inboard side face 46 and an outboard side face 48. In the preferred form, the inboard side face 46 (FIGS. 4 and 6) has a planar or substantially flat geometry, whereas the outboard side face 48 (FIGS. 5-6) has a slight bevel formed therein as defined by a beveled edge 49 disposed generally at an upstream side of the blade bolt openings 33. From this beveled edge 49, the outboard side face 48 tapers in an upstream direction at an angle of about 3° to about 7° to the upstream cutting edge 40.

Both of the side faces 46 and 48 of each knife blade 16 incorporate a channeled pattern 50 formed to impart the desired rough-textured surface configuration to the cut product surfaces 18. As shown, the inboard side face 46 of the knife blade 16 has a plurality of shallow channels 52 formed therein to extend substantially across the cutting zone defined by the cutting edge 40 exposed within the knife fixture 10, between the associated bolt openings 33, for cutting products 12. In the preferred form, these channels 52 are formed as grooves or slots each having a width of about 0.025 to about 0.035 inch, a depth of about 0.015 inch, and a length of about 0.50 inch, with the channels being formed on groove centers spaced apart by about 0.50 to about 0.60 inch. On the inboard side face 46, leading edges of these grooves or slots 52 are spaced in a downstream direction relative to the associated cutting edge 40, whereby the channeled pattern 50 does not interfere with smooth-cut engagement of the cutting edge 40 with products 12 propelled through the knife fixture 10. In the preferred form as shown, the grooves or slots 52 on the inboard face 46 of the knife blade 16 having leading ends aligned generally with a leading or upstream end margin of the associated blade bolt openings 33, and trailing or downstream ends extending to and terminating generally at the blade trailing end 44.

By contrast, in the preferred form, the outboard or beveled side face 48 of each knife blade 16 includes a similar channeled pattern 50 defined by grooves or slots 52 of similar size, shape, and spacing, but wherein the beveled side face pattern 50 is defined by upstream channel ends bridging the beveled edge 49 by a short increment on the order of about 0.125 inch. As shown (FIG. 5), the leading ends of these beveled side channels 52 also terminate in downstream-positioned relation to the associated upstream-end cutting edge 40 to avoid interfering with smooth-cut engagement between the cutting edge 40 and product 12 propelled through the knife fixture 10. Trailing ends of the channeled pattern 50 on the beveled side face 48 terminate, in the preferred form, in spaced relation upstream relative to the blade trailing edge 44.

FIG. 8 shows a modified channeled pattern geometry for the outboard or beveled side face of a knife blade, in accordance with one alternative preferred form of the invention. More particularly, as shown, a modified knife blade 116 (having an inboard side face configured generally as shown and described in FIG. 4) has an outboard side face 48 defined by a beveled edge 49 disposed generally at an upstream side of a pair of bolt openings 33. A sharp leading or cutting edge 40 is interrupted by a pair of appropriately spaced notched recesses 42 for mounting the blades in a stacked array, as previously shown and described. A channeled pattern 50′ on the outboard or beveled side face 48 is defined by an array of grooves or slots 152 which extend generally but not precisely in the direction of product travel. As shown, the grooves or slots 152 are set at a slight angle, such as an angle of about 3°, relative to the direction of product flow. Stated alternatively, the grooves or slots 152 are oriented at an angle of about 87° to the associated cutting edge 40.

In operation and use, each product 12 such as a potato is propelled by the hydraulic flume with sufficient velocity and kinetic energy to pass through the grid of knives 16 supported by the knife fixture 10, thereby cutting the product into a plurality of elongated strips 14 having the selected cross sectional size and shape. As the product 12 engages the upstream cutting edge 40 of each knife blade 16, the product is smooth-cut to define the strip surfaces of desired geometric configuration. However, as the smooth-cut product travels downstream past each knife blade 16, the smooth-cut surfaces engage the channeled patterns 50 on the opposite side faces 46, 48 of the knife blades 16 or 116, resulting in a controlled and highly desirable roughening of the cut surface. Importantly, by orienting the channels 52 of the patterns 50 to extend generally in the direction of product travel, namely, in an upstream-downstream direction of orientation, and generally perpendicular to the associated cutting edge 40, the cut product strips 14 and the propelling hydraulic flow stream are believed to flush any residual product debris from the channels 52, thereby keeping the channels 52 open and clean for continued rough-texturing of cut product surfaces for substantially continuous product cutting operation. Roughening of the cut surface is desirably enhanced by use of the slightly angled pattern 50′ (FIG. 8), but wherein the angular orientation of the channels 152 is small, i.e., the channels 152 still extend generally but not precisely in the direction of product flow while maintaining desirable channel flushing of any residual product debris.

In addition, by orienting the orthogonally extending pairs of adjacent knife blades 16 in a partially overlapped configuration, i.e., wherein the leading or cutting edges 40 of each trailing pair of knife blades 16 disposed a short distance upstream relative to the trailing edges 44 of the upstream-located pair of knife blades 16 or 116, it is believed that potatoes propelled through the knife fixture 10 are better forced into engagement with the blade grooves 52 rough-texturing of the cut potato surfaces.

The rough-textured product strips 14, produced by the knife blades 16 and associated knife fixture 10 of the present invention, have demonstrated improved and desirable surface crispness when subjected to post-cutting preparation steps such as parfrying and/or finish frying in the case of French fry potato strips. Alternately, such rough-texture product strips 14 have demonstrated improved batter pick-up and/or crispness when the product strips are coated as by immersion or spraying with a selected batter composition. In either case, the rough-textured product strips 14 exhibit improved finish-prepared crispness characteristics, or alternately may be processed with a reduced fry time to achieve a desirable combination of product characteristics comparable to smooth-cut products which have been subjected to a longer fry time. Improved finished product hold time is also achieved.

The rough-textured product strips 14 may also be processed in accordance with U.S. Pat. Nos. 5,302,410; 5,393,552; 5,885,639; and 6,033,697, which are incorporated by reference herein. These patents disclose production processes for producing parfried and frozen French fried potato strips which are treated and/or batter coated to achieve improved crispness characteristics in a finish prepared state. When these processes are utilized with the rough-textured cut strips 14 prepared by use of the improved knife blade 16 or 116 and associated improved knife fixture 10 of the present invention, further beneficial improvements in finish prepared product crispness and product holding time are realized.

A variety of modifications and improvements in and to the improved knife blade and related cutting system of the present invention will be apparent to those persons skilled in the art. For example, it will be understood that the invention may be embodied in a knife blade 16 having a beveled configuration on both sides thereof. It will also be understood that the knife blade of the invention may be used in a knife fixture in combination with one or more knife blades having a conventional geometry for cutting products without surface disruption. In addition, while the invention is shown and described with respect to an hydraulic cutting system, it will be recognized and appreciated that the invention may be employed with other types of cutting systems for cutting vegetable products such as potatoes and the like. Accordingly, no limitation on the invention is intended by way of the foregoing description and accompanying drawings, except as set forth in the appended claims.

What is claimed is:

1. A knife blade for producing rough surface French fry strips, said knife blade comprising:
an elongated knife blade element defining a sharp cutting edge, a trailing edge, and a pair of opposed side faces;
each of said pair of opposed side faces having a pattern of shallow channels formed therein each having a leading end spaced from said cutting edge and extending generally perpendicular to said cutting edge.

2. The knife blade of claim 1 wherein said shallow channels each have a width of about 0.025 to about 0.035 inch, a depth of about 0.015 inch, and a length of about 0.50 inch, and further wherein said shallow channels are formed on groove centers spaced apart by about 0.50 to about 0.60 inch.

3. The knife blade of claim 1 wherein said cutting edge has a generally straight configuration.

4. The knife blade of claim 1 wherein said opposed side faces are generally planar.

5. The knife blade of claim 4 wherein one of said side faces defines a beveled edge, said one side face tapering from said beveled edge to said cutting edge at an angle of from about 3° to about 7°.

6. The knife blade of claim 5 wherein said channels formed in said one side face bridge said beveled edge.

7. The knife blade of claim 6 wherein said channels formed in said one side face have trailing ends terminating in spaced relation to said trailing end of said blade element.

8. The knife blade of claim 6 wherein said channels formed in said beveled edge are oriented at about 87° to said cutting edge.

9. The knife blade of claim 5 wherein said channels formed in said side face opposite said one side face having trailing ends terminating substantially at said trailing end of said blade element.

10. A knife fixture for producing rough surface French fry strips, said knife fixture comprising:
a plurality of elongated knife blades each defining a sharp cutting edge, a trailing edge, and a pair of opposed side faces;
each of said pair of opposed side faces having a pattern of shallow channels formed therein each having a leading end spaced from said cutting edge and extending generally perpendicular to said cutting edge; and
a fixture frame for supporting said knife blades in a stacked relation with said cutting edges of said knife blades oriented in a common upstream direction for engaging and cutting potatoes and the like propelled through said fixture frame.

11. The knife fixture of claim 10 wherein said fixture frame supports said knife blades in an axially and radially staggered pattern of spaced-apart blade pairs, with each blade pair oriented angularly to adjacent stacked blade pairs.

12. The knife fixture of claim 11 wherein each blade pair is oriented substantially orthogonally to adjacent stacked blade pairs.

13. The knife fixture of claim 10 wherein said cutting edges of said knife blades each have a generally straight configuration.

14. The knife fixture of claim 10 wherein each of said knife blades includes a pair of mounting holes formed therein generally at opposed ends thereof, said cutting edge extending through a cutting zone generally between said mounting holes.

15. The knife fixture of claim 11 wherein said opposed side faces of each of said knife blades are generally planar.

16. The knife fixture of claim 15 wherein said opposed side faces of each of said knife blades comprises an inboard side face, and an outboard side face, said outboard side face having a beveled edge formed therein and bridged by said channels.

17. The knife fixture of claim 16 wherein said outboard side face tapers from said beveled edge to said cutting edge at an angle of from about 3° to about 7°.

18. The knife fixture of claim 16 wherein said channels formed in said outboard side face have trailing ends terminating in spaced relation to said trailing end of said knife blade, and wherein said channels formed in said inboard side face having trailing ends terminating substantially at said trailing end of said knife blade.

19. The knife blade of claim 16 wherein said channels formed in said beveled edge are oriented at about 87° to said cutting edge.

20. The knife fixture of claim 10 wherein said knife blades are supported by said fixture frame in partially axially overlapping relation.

21. The knife fixture of claim 20 wherein each of said knife blades has a pair of notched recesses interrupting said cutting edge thereof, said notched recesses being formed at predetermined locations and with predetermined depths for receiving and supporting the trailing edges of an axially upstream-adjacent pair of said knife blades.

22. The knife fixture of claim 10 wherein said shallow channels each have a width of about 0.025 to about 0.035 inch, a depth of about 0.015 inch, and a length of about 0.50 inch, and further wherein said shallow channels are formed on groove centers spaced apart by about 0.50 to about 0.60 inch.
